(19) United States
(12) Patent Application Publication
(10) Pub. No.: US 2009/0189123 A1
(43) Pub. Date: Jul. 30, 2009

(54) METHOD AND APPARATUS FOR A MULTI PURPOSE DATA AND ENGINEERING SYSTEM 205

(76) Inventor: How Kiap Gueh, Singapore (SG)

Correspondence Address: HOWREY LLP-CA, C/O IP DOCKETING DEPARTMENT, 2941 FAIRVIEW PARK DRIVE, SUITE 200, FALLS CHURCH, VA, 22042-2924, US

(21) Appl. No.: 12/088,402

(22) PCT Filed: Sep. 8, 2006
(86) PCT No.: PCT/SG06/00262

§ 371 Date: Mar. 27, 2008

(30) Foreign Application Priority Data
Sep. 27, 2005 (SG) 200506252-6

(51) Int. Cl. C01B 3/34; B63J 1/00; B63J 4/00; F02B 43/00; F02C 7/22; H01M 8/06

(52) U.S. Cl. 252/373; 210/747; 204/168; 205/742; 123/3; 60/780; 429/17

(57) ABSTRACT

The present invention relates to a method of a manufacturing facility fitted and equipped onboard a marine vessel, the vessel first taking in seawater to fill the vessel ballast tanks using the vessel's sea chests, ensuring a reasonable stability factor to allow for continuous and safe operation of the manufacturing facility.

### FIELD OF THE INVENTION

The present invention relates to a method of a manufacturing facility fitted and equipped onboard a marine vessel, the vessel first taking in seawater to fill the vessel ballast tanks using the vessel's sea chests, ensuring a reasonable stability factor to allow for continuous and safe operation of the manufacturing facility.

The present invention makes use of a marine vessel, ship, barge, or marine platform vehicle (all collectively known as marine vessel), to produce products that are then subsequently delivered to distribution systems, predominantly terrestrial, land-based ports, terminals and harbors. Distribution systems can also refer to specially constructed floating structures that are close to a land-based port terminal.

The products produced are: treated water, bottled water, packaged water, alcoholic beverages, industrial chemicals, industrial gases, salt, hydrocarbons including methane, diesel and other hydrocarbon distillates.

Further products are metals, iron, steel, aluminum, and manufactured items such as electronic components, devices and assembled devices, and the manufacturing facility also produces semiconductors, pharmaceuticals and other typical industrial goods produced in land-based factories.

The invention's concept is to make use of the marine vessel as a capture system to intake raw materials from either the sea, or from a multiple number of land terminals, perform manufacturing onboard the vessel, or “in-situ”, while the marine vessel is moving from a predetermined point of departure at a first remote site to a second predetermined point of arrival at a second remote site. Variations include using the marine vessel to perform part of an entire process of a particular manufacturing activity.

The ship's ballast system is also disclosed as one of the means to facilitate the above manufacturing activity performed on the marine vessel.

Details of the above are also disclosed in Singapore patent application 200506252-6.

### SUMMARY OF THE INVENTION

It is object of the present invention to provide a method of a manufacturing facility fitted and equipped onboard a marine vessel, the vessel first taking in seawater to fill the vessel ballast tanks using the vessel's sea chests, ensuring a reasonable stability factor to allow for continuous and safe operation of the manufacturing facility.

The present invention has several configurations, of which the “best mode” processes, methods are disclosed:

Water and Water Related Products

For making treated water, the marine vessel will capture seawater using the seawater intake valves also called sea chests in the maritime industry, to fill up the ship's ballast tanks. The ship will have a seawater treatment plant onboard that incrementally draws seawater from the ballast system to produce treated water. This is advantageous since the composition of seawater will be fairly consistent during treatment especially when the vessel is simultaneously producing the treated water and delivering it to its intended distribution system. Filling the ballast system also ensures that the ship is of correct tonnage since the incrementally produced treated water may not be of sufficient weight during the early phase of treatment and vessel voyage.

The treated water may also be subjected to other types of manufacturing processes, such as carbonation, bottling and packaging. It may further be utilized as a raw material to allow fermentation of alcoholic beverages like beer.

A method of the vessel loading hops, barley and other ingredients for beer malting from different land points while treated water is produced and fermentation is performed onboard is also disclosed. Further, a method is also disclosed where beverages are manufactured on the vessel by loading various raw materials such as PET bottles or pellets, packaging materials etc, and producing the final product—much like a ship-based factory.

Water Treatment Means—Additionally, also disclosed is a method of producing treated water by first separating seawater or a raw non-treated water source, into hydrogen and oxygen, most suitably using a electrolysis device, and then again combining the hydrogen and oxygen in a fuel cell to yield pure water. Since the fuel cell also generates electricity, the overall process is made efficient. The pure water is then passed into a re-mineralization system to make it potable. This method can be implemented in a land plant, or on the marine vessel. The electrolysis device may be operable by means of the vessel powerplant, or another device such as a solar or wind energy device, further reducing the direct fuel and energy consumption of the overall process.

Water Revenue Augmentation Means—Additionally, a marine vessel performing treatment of water and at the same time delivery cargo is disclosed. The cargo may be standard shipping containers, or bulk cargo such as commodities, and allows for a mixed activity of the vessel to maximize revenue. Note that many freight ships may carry empty cargo loads during its return journey.

Salt

The present invention also makes use of the marine vessel as a means to capture seawater, or brine, to produce salt, and the salt product may be packaged before delivery to a distribution system. There are two modes, one of which is the method where the vessel captures seawater, and passes the seawater into a plant onboard to produce salt. The plant may be a vacuum evaporation device, or a thermal evaporation system. The second mode is to load brine discharge from a seawater desalination plant on land, and perform salt recovery onboard the ship. Salt is also considered an industrial product.

Chemicals and Industrial Gas

The present invention also makes use of the marine vessel as a means to capture seawater, and or other raw materials, and produce the desired chemicals and industrial products. A seawater electrolysis system may be utilized to produce different industrials gases, or combine these gases to obtain a desired chemical. Disclosed in Singapore patent application 200506252-6 also is a means to allow the vessel to intake different raw materials needed for chemicals production onboard, from different distribution systems.

Iron and Steel, Metals and Ore

The present invention also makes use of the marine vessel as a means to collect scrap metal, or metal ore, or both, and perform ore processing, scrap metal smelting onboard the vessel, while vessel is delivering the eventually finished metal product to multiple distribution systems.

Hydrocarbons (Excess H₂ from Seawater)

The present invention also makes use of the marine vessel to collect a range of carbonaceous feedstock such as wood, waste, grass, scrap rubber, coal, and heat the feedstock (heating includes gasification, pyrolysis etc as disclosed in Singapore patent application 200506252-6), to get a gas called syngas, containing carbon dioxide, carbon monoxide and hydrogen.

The syngas is then subjected to reacting with a catalyst material to produce a synthetic hydrocarbon, ranging from methane gas to heavy fuel distillates. Polymer synthesis means is achieved by means of Fischer-Trosph or Sabatier method, depending on whether carbon monoxide (syngas) or carbon dioxide is preferred input feedstock derived component.

The present invention also introduces excess hydrogen into this syngas and the excess hydrogen is derived from seawater by means of a vessel-mounted electrolysis device, which can be supplied power by the vessel's powerplant, or a solar and or wind energy device.

Hydrocarbons from Sewage on Ship

The present invention also makes use of the marine vessel to load sewage material into vessel-equipped bioreactors that facilities input of an anaerobic catalyst, and using waste heat from the vessel powerplant and powerplant cooling system, promotes gas effluent production of methane and carbon dioxide. The methane gas is isolated and stored for subsequent delivery to a plurality of land distribution systems.

Hydrocarbons from Syngas Produced on Ship

The present invention also makes use of a marine vessel to produce syngas, and sending the syngas to the ship's onboard production plant to produce hydrocarbons, and then delivering the hydrocarbon product to a plurality of land distribution systems.

The marine vessel may also load syngas produced on land, and produce hydrocarbons onboard while making delivery of the product in progress to its intended site (land distribution system).

Marine Vessel with Flex Fuel Powerplant Design

The present invention also includes and discloses a method for a marine vessel with a flexible fuel intake for its powerplant, by allowing carbonaceous materials to be utilized as fuel to operate the marine vessel, by producing syngas from the feedstock and using the syngas as fuel for combustion.

Special Fischer-Trosph (Ft)/Sabatier Rack Mounted Design

The present invention also includes FT/Sabatier reactor design that comprises of a plurality of micro-reactors each connected to gas lines that supplies the reactors with the reactant gases for synthesis. The design allows skid mounting (or rail mounting) for easy shipment and module construction.

### BRIEF DESCRIPTION OF THE DRAWINGS

Illustrative embodiments of the present invention will now be described, by way of example, with reference to the accompanying drawings, in which:

FIG. 1 illustrates the process flow of a marine vessel capturing seawater into its ballast tanks, sending the seawater from the ballast tanks to water treatment system, and treating seawater into treated water, which is utilized by a manufacturing system onboard the said vessel.

FIG. 2 illustrates construction and layout of Sabatier reaction chambers for mounting on a vehicle system such as the marine vessel.

FIG. 3 illustrates capture systems connected to the vessel sea chests and ballast system to extract hydrogen and carbon for subsequent synthesis into hydrocarbon product, and in the case of methane, may be optionally liquefied into LNG onboard.

FIG. 4 illustrates capture systems connected to the vessel ballast system for extraction of hydrogen from seawater, note that Sabatier reaction system may be a Fischer-Trosph reaction system and may be connected to a syngas production source, and additional hydrogen is fed for synthesis of heavier hydrocarbon products.

FIG. 5 illustrates the present invention where multiple carbon and hydrogen capture systems are connected to the vessel hydrocarbon synthesis to produce hydrocarbon products, and methane may be liquefied onboard during product synthesis and delivery—note that sewage and anaerobic reactors producing methane may be sent directly for processing and storage.

FIG. 6 illustrates the present invention where coal is loaded into vessel, gasified, and further passed into the hydrocarbon synthesis reactor, steam source may be utilized as an option to introduce hydrogen instead of seawater electrolysis hydrogen capture means.

FIG. 7 illustrates cross section layout view of vessel.

FIG. 8 illustrates the layout diagrams of a vessel and its various cargo hold which may hold different components including the onboard manufacturing system depending on the vessel's mode (to produce hydrocarbon, water or finished products or chemicals).

### DETAILED DESCRIPTION OF THE PREFERRED EMBODIMENTS

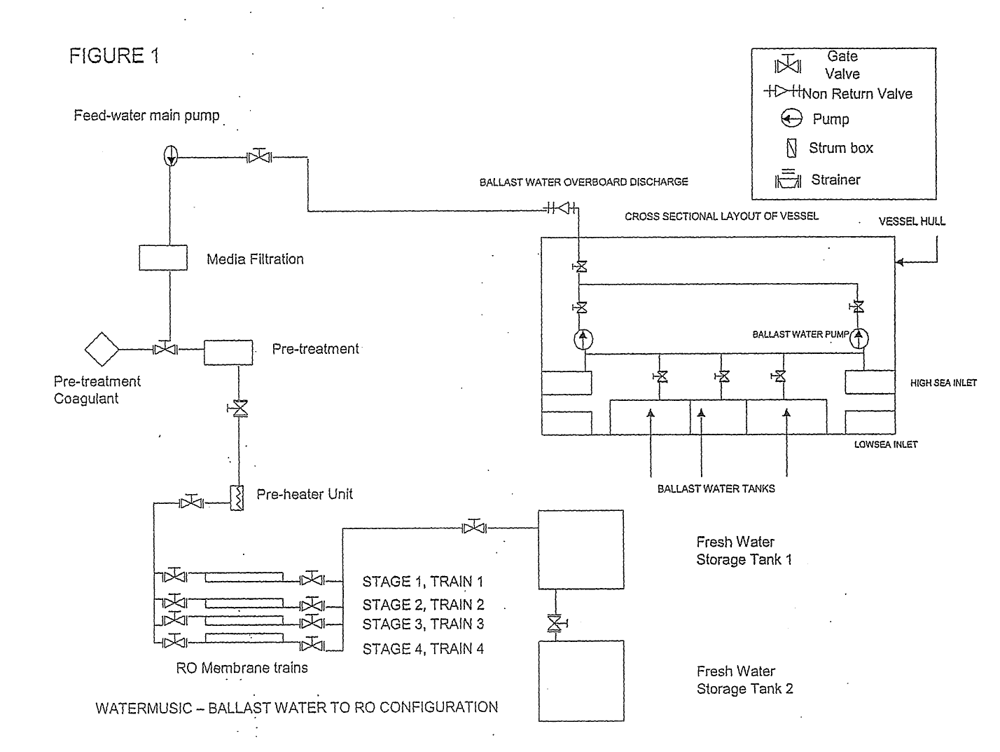

With reference to FIG. 1, a process flow of the present invention is disclosed; a marine vessel having a vessel ballast system is utilized as a raw material source for the treatment and production of treated water onboard, with the subsequent delivery of the treated water to a plurality of distribution systems.

Seawater is captured by the marine vessel by means of sea chests, or seawater intake valves, and fills up the ballast system to a predetermined level. The onboard treatment plant of the present invention will then incrementally draw seawater from the ballast system to produce treated water.

The ballast system, when filled with seawater to a predetermined level, will allow the marine vessel to travel in its designed hull draft level, and at the same time providing seawater for treatment onboard.

Notes: The water treatment plant may be a seawater desalination unit: a plant that deploys reverse osmosis filters, or utilized a variety of seawater treatment technologies available. In the case of an existing vessel, true “plug and play” can be implemented since the ballast discharge pipes can be re-connected by means of additional steel piping to the seawater treatment plant—many such plants are offered as skid-mounted commercial units, some even fully containerized with standardized shipping containers that may come with treatment manufacturing standards such as HACCP. In the “plug and play” configuration and operating mode, the marine vessel can be performing other activities while the water treatment plant and its relevant piping connections are established. This facilitates higher “value-added” activities such as beverage production and bottling, without any compromise to manufacturing and hygiene standards.

In the case of the production of alcoholic beverages such as beer, the use of standardized or modular containerized units for fermentation and brewing prevents contamination from elements during vessel transportation from one remote site to another. It should be further noted that in the case of beverage manufacturing and bottling operations on the marine vessel, the ballast system can also provide a means to reduce shipboard oscillation due to the action of waves while vessel is in transit from one remote site to a second remote site.

In the case of the production and recovery of salt, the thermal evaporator system is mounted into a suitable part of the vessel, and seawater is passed from either the sea chests or ballast system, or both to the system.

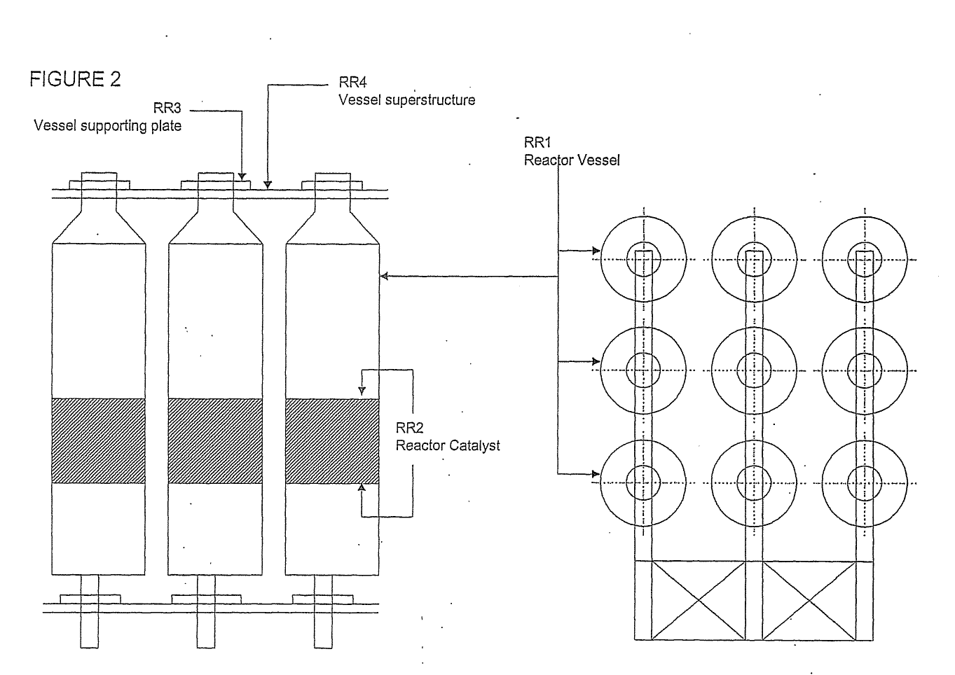

With reference to FIG. 2, a modular Fischer-Trosph/Sabatier reactor design is disclosed. Small reactor vessels are combined in a skid or rack mounted package, and each vessel is further provided gas pipes that connects to a (i) syngas source or (ii) CO gas source, or (iii) CO.sub.2 gas source, or (iv), a H₂ gas source, or a combination thereof. Reactor vessels RR1 are arranged in a suitable orientation, and then attached to the vessel superstructure RR4 by means of vessel supporting plates RR3. Each vessel comprises of a specified, predetermined catalyst material RR2. In the embodiment of this invention, each vessel may further comprise of different reactor catalyst thus allowing synthesis of a multitude of hydrocarbon products (of different polymer lengths) in a single module.

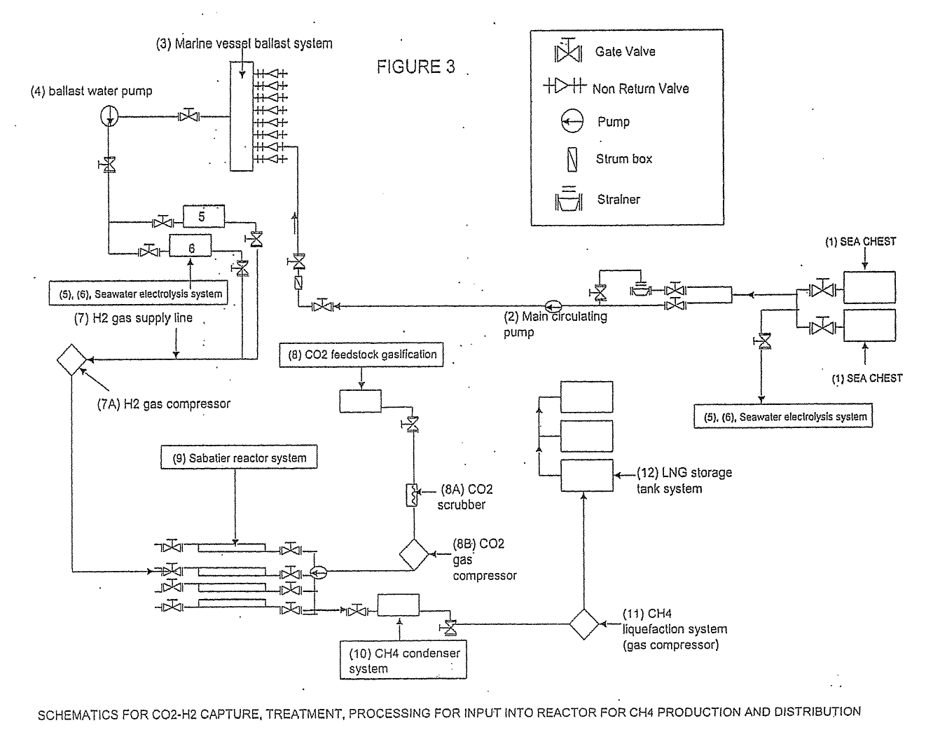

With reference to FIG. 3, the present invention makes use of the marine vessel to capture raw materials such as carbonaceous feedstock including wood, biomass, coal, disposed waste matter etc, then using a predetermined thermal treatment means, derive syngas or a gas mixture containing hydrogen (H₂) and carbon monoxide (CO), or carbon dioxide (CO₂). This gas mixture is then passed into a methanation reaction system to produce synthetic natural gas. However, the gas mixture (syngas) may also be passed into a Fischer-Trosph (FT) reaction system to produce synthetic hydrocarbons ranging from methane to longer polymer hydrocarbons. Excess hydrogen may facilitate the methanation and or FT reaction processes (better reaction efficiency or higher probability of synthesis of heavier hydrocarbon products. The ballast system (3) may be utilized again as the seawater source (to extract excess hydrogen), or the seawater electrolysis device (5) and (6) may extract hydrogen from seawater intake from the vessel sea chests, or ballast system or both. The CO2 feedstock gasification (8) may be a single gasification unit, or an array, and may be a syngas production unit. This gasification unit (8) is to derive syngas or a gas mixture containing CO, CO₂ and H₂. It should be noted that (5) and (6), seawater electrolysis device then supplies excess hydrogen when required in the process of the present invention. Note that the Sabatier reactor system (9) may be substituted for a methanation reactor system, or a combination, depending on process design. In some cases, methane gas produced from the present invention may be liquefied by means of (11) liquefaction units onboard the marine vessel, and be stored in LNG (liquefied natural gas) containment system in the vessel.

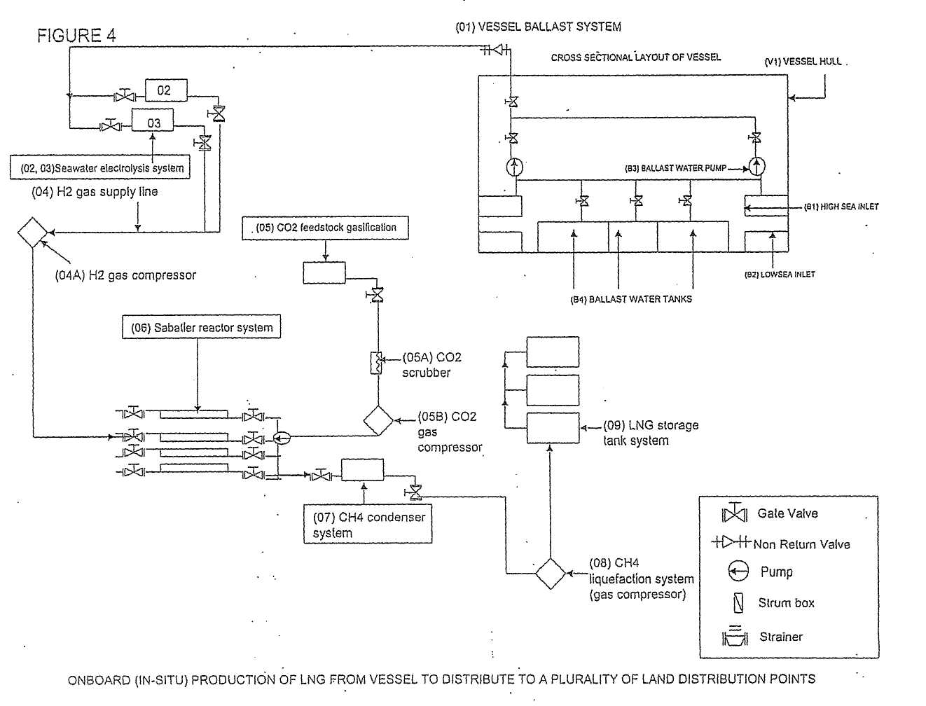

With reference to FIG. 4, the marine vessel produces excess hydrogen from seawater captured directly from the vessel ballast system instead of relying on the vessel sea chests. FIG. 4 is similar otherwise to that of FIG. 3.

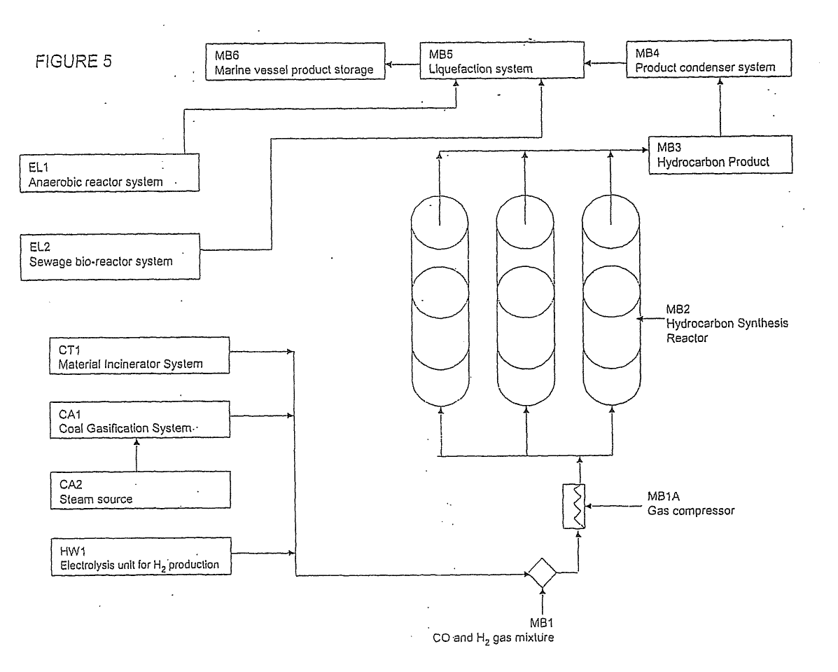

With reference to FIG. 5, a process flow is disclosed whereby the vessel may feature a MB2 hydrocarbon synthesis reactor system, and a number of feedstock capture units that performs feedstock capture and processing. CT1 is a material incinerator system that produces CO2 gas stream for subsequent Sabatier production conversion. CA1 is a coal gasification system that allows input of steam from CA2. Sewage can also be captured by means of EL1 and EL2 where gas effluent containing methane and carbon dioxide is isolated so that methane is then subsequently liquefied and stored in the vessel—liquefaction may not be implemented depending on vessel size, product flow rate and required rate of product delivery.

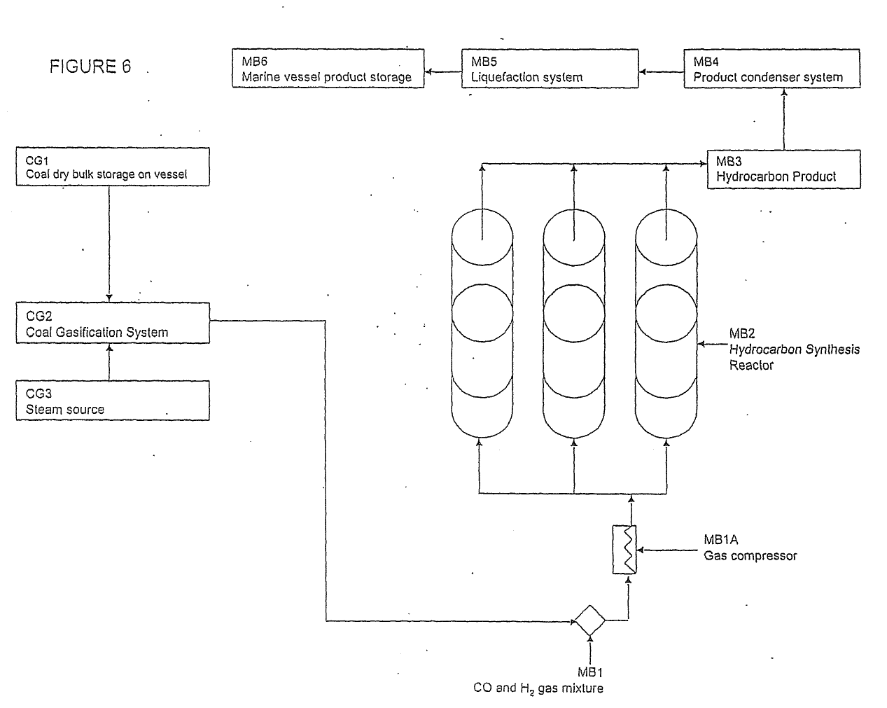

With reference to FIG. 6, a dedicated vessel using coal as the carbonaceous feedstock is disclosed. Coal is captured from a land source into the feedstock system CG1, and is gasified in the gasification system CG2 with the addition of steam from CG3. For existing LNG ships using a steam powerplant, this reduces the implementation cycle since the powerplant can also produce steam for dual use—vessel powerplant and process synthesis.

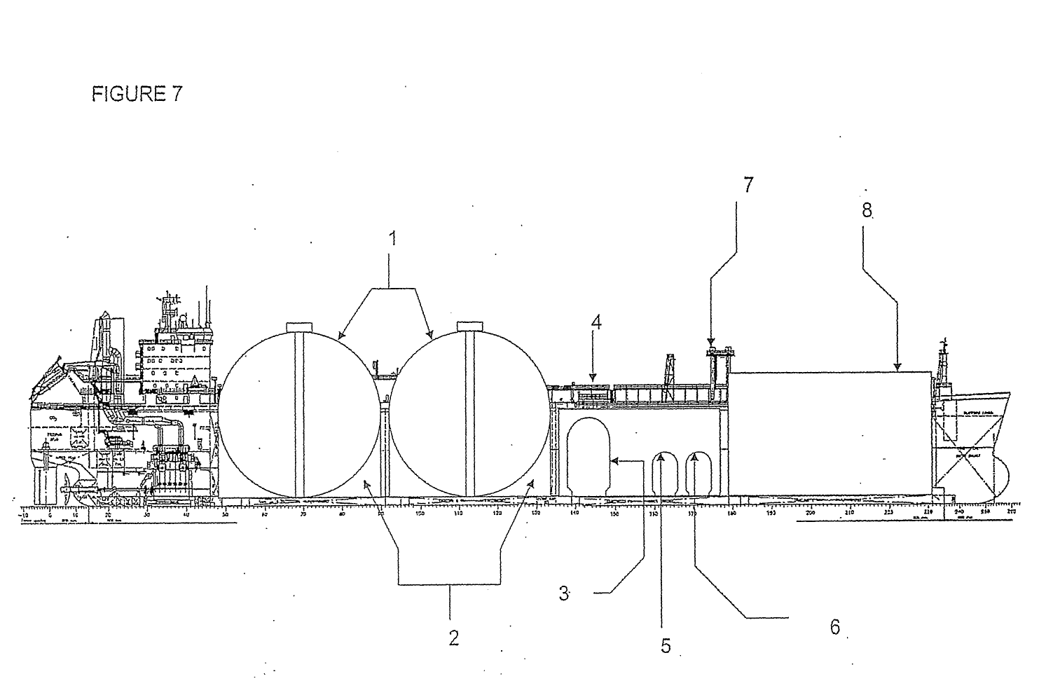

With reference to FIG. 7, cross section of the marine vessel is disclosed where (1) is the product storage and containment system, (2) is the ballast tanks of the ship's ballast system, (8) is the carbonaceous feedstock storage unit, (3), (5) and (6) are components and sub-systems of the process equipment including feedstock processing, reactor devices. (7) is the product distribution manifold that finally distributes the product (may be liquefied natural gas) to a distribution system. (4) may be the seawater electrolysis device in a suitable enclosed structure.

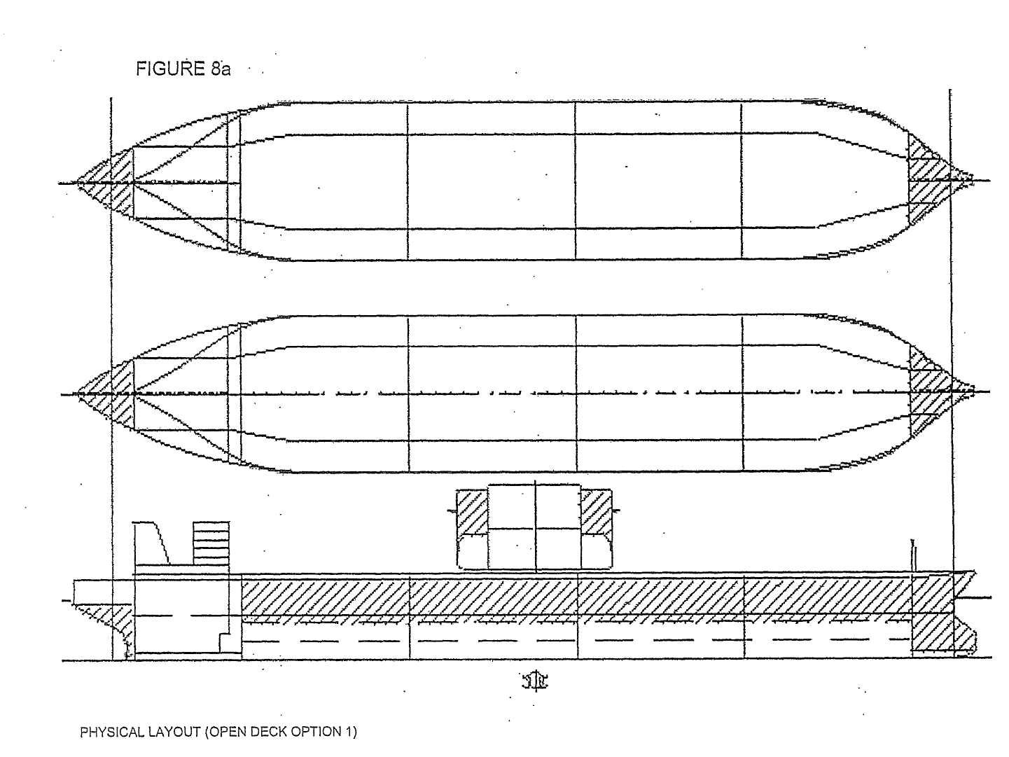

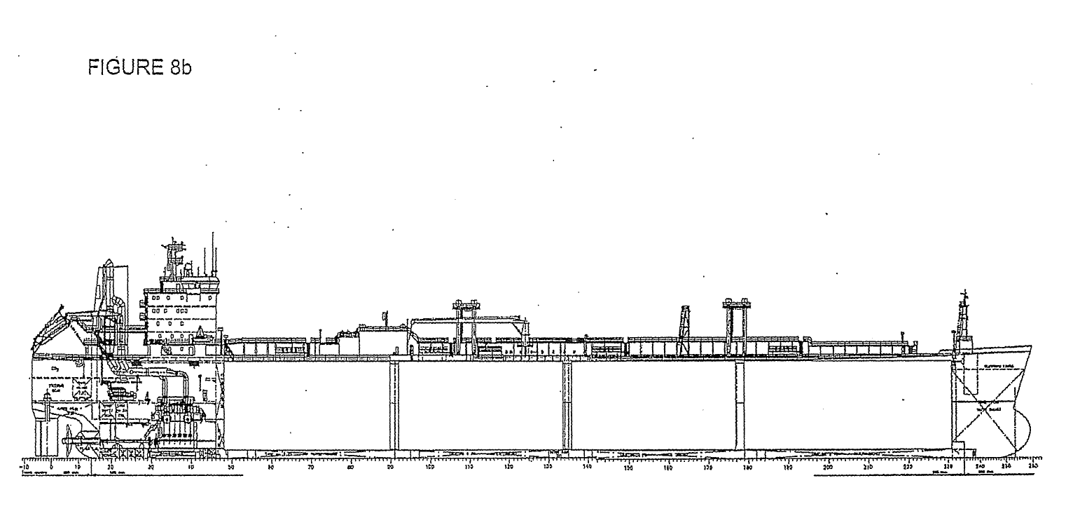

With reference to FIG. 8, the outline of the various view of the marine vessel is disclosed. (1) is the open deck of the marine vessel that can contain a superstructure (not shown) that is constructed according to any of the preferred embodiments of the present invention. (2) shows the top view layout of the space available for mounting a the said superstructure (not shown) onto the marine vessel. (3) is the generalized illustration of the cargo hold that can accommodate different components and sub-systems according to each preferred embodiment of the present invention.

Modifications within the spirit and scope of the invention may readily be effected by persons skilled in the art. It is to be understood, therefore, that this invention is not limited to the particular embodiments described by way of example hereinabove.

1. A method for producing a manufactured item including a first remote site comprising a marine vessel, a second distribution site, and a third distribution site wherein the first remote site captures seawater for use as a primary raw material, and performs intake of a predetermined number of secondary raw materials into vessel from the second distribution site, and delivering the manufactured item to the third distribution site, the method comprising: (a) receiving at the third distribution site a manufactured item from the first remote site; (b) vessel receiving at the second distribution site a predetermined number of secondary raw materials; (c) first remote site performing manufacturing to product said item during journey from second distribution site to third distribution site.

2. A process for producing treated water including a first remote site comprising a marine vessel, and a second distribution site, wherein the first remote site captures seawater and produces treated water, and the second distribution site distributing treated water, the process comprising: (a) receiving at the second distribution site treated water, wherein the treated water is made at the first remote site by a method comprising: (i) capturing seawater from vessel sea chests; (ii) filling vessel ballast system with captured seawater to a predetermined level; (iii) drawing seawater from ballast system to a seawater treatment plant to produce treated water; and (iv) storing treated water in vessel cargo system; and (b) delivering treated water from the remote site to the second distribution site.

3-29. (canceled)

30. A method and apparatus for a flexible fuel marine vessel powerplant system comprising a marine vessel including a feedstock module, a thermal device, and a powerplant unit, where feedstock module is interconnected to the thermal device, said device further converting a carbonaceous material in said module into a syngas blend containing carbon monoxide and hydrogen by thermal means, further sending syngas into powerplant unit to produce energy for the marine vessel.

31. A method and apparatus as claimed in claim 30, carbonaceous material contain biomass, disposed waste matter, scrap rubber, sewage, wood, coal, lignite coal, agricultural waste matter, grass, municipal waste matter, industrial waste matter.

32. A method and apparatus as claimed in claim 30, thermal device is a plasma gasification system.

33. A method and apparatus as claimed in claim 30, thermal device is a thermal gasification system.

34. A method and apparatus as claimed in claim 30, powerplant unit is an internal combustion engine.

35. A method and apparatus as claimed in claim 30, powerplant unit is a gas turbine.

36. A method and apparatus as claimed in claim 30, powerplant unit is a combined cycle gas and steam turbine.

37. A method and apparatus as claimed in claim 30, powerplant unit is a fuel cell device.

38. A method and apparatus as claimed in claim 30, a specific quantity of syngas blend is partially converted into a predetermined hydrocarbon product.

39. A method and apparatus as claimed in claim 30, a specific quantity of syngas blend is partially converted into a predetermined fuel distillate product.

40. A method and apparatus as claimed in claim 30, a specific quantity of syngas blend is partially converted into a predetermined chemical product.

41. A method and apparatus as claimed in claim 30, marine vessel is adapted with an electrolysis block to extract excess hydrogen from seawater and adding excess hydrogen into syngas blend.
